(19) United States
(12) Patent Application Publication
(10) Pub. No.: US 2017/0091358 A1
(43) Pub. Date: Mar. 30, 2017

(54) MODEL-BASED PROGNOSIS OF MACHINE HEALTH

(71) Applicant: CATERPILLAR INC., Peoria, IL (US)

(72) Inventors: Yanchai ZHANG, Dunlap, IL (US); Yang WANG, Dunlap, IL (US); Zhaoxu DONG, Dunlap, IL (US); Xuefei HU, Dunlap, IL (US)

(73) Assignee: CATERPILLAR INC., Peoria, IL (US)

(21) Appl. No.: 14/866,980

(22) Filed: Sep. 27, 2015

(51) Int. Cl. G06F 17/50

(52) U.S. Cl. CPC G06F 17/5018

(57) ABSTRACT

A method and a system for providing a model-based machine health prognosis are disclosed. According to certain embodiments, the method includes obtaining one or more performance parameters of a machine. The method also includes determining whether cavitation occurs based on the one or more performance parameters. If cavitation occurs, the method further includes simulating, based on the one or more performance parameters, the occurrence of the cavitation using a computational fluid dynamics (CFD) model. The method further includes determining, based on output from the simulation of the cavitation, a remaining useful life of the machine using a finite element analysis (FEA).

### TECHNICAL FIELD

The present disclosure relates generally to model-based prognosis of machine health, and more particularly, to model-based methods and systems of monitoring machine health and predicting the remaining useful life of the machine.

### BACKGROUND

Machines working under hostile environments can accumulate damage quickly. For example, hydraulic pumps used in hydraulic fracturing or “fracking” operations must pump a high-pressure fracturing fluid, usually a mixture of water, sand, and chemicals, into a wellbore for creating cracks in deep-rock formations located under the earth's surface. Components of these pumps are constantly subject to high working pressure and may frequently break down due to material wear and/or fatigue.

Moreover, like other pressurized fluid systems, a hydraulic pump is often susceptible to the phenomenon known as “cavitation.” Cavitation generally refers to the formation of vapor bubbles within a fluid system when the fluid's operational pressure drops below the fluid's vapor pressure. For example, cavitation can occur in flowing liquid when the speed or velocity of the liquid increases such that the pressure in the pump drops below the vapor pressure of the liquid, resulting in local vaporization of the liquid, which in turn creates a cavity (i.e., hole) or void within the flowing liquid. This low-pressure cavity generally comprises a swirling mass of liquid droplets and vapor bubbles that form and reform many times a second.

Once formed, the low-pressure cavity is generally swept swiftly downstream into a region of high pressure where it suddenly collapses as surrounding liquid rushes in to fill the void. As the cavity is collapsing, each vapor bubble within the cavity implodes, releasing a momentary burst of concentrated energy. The released energy stresses the material surface of the pump beyond its elastic limit and, given sufficient time, may cause material erosion, known as cavitation damage.

High pressure coupled with cavity formations can be problematic to the performance of a hydraulic pump. For example, the fluid end of a pump needs to be replaced every few hundred working hours. Without proper measures to monitor the pump health and service the pump timely, catastrophic failure may happen and cause tremendous financial or even human life losses. Conventionally, some pump operators schedule maintenance activities at predetermined time intervals. However, this may lead to premature replacement of still healthy pump components. Alternatively, some operators choose to service the pump only when the pump performance has deteriorated. However, the ordering and shipping of pump components often take time and therefore may cause prolonged machine down time. Though spare pump parts can be kept on site, maintaining an inventory of expensive parts impacts the operator's precious operation capital. Therefore, a prognostic tool is needed to monitor the pump health and accurately predict the pump's remaining useful life.

U.S. Pat. No. 7,143,016 (the '016 patent), issued to Discenzo et al. on Nov. 28, 2006, discloses a system capable of diagnosing the operating condition of a hydraulic pump, including pump faults, pump cavitation, and failure and/or degradation in one or more pump components. The disclosed system uses one or more sensors to detect parameters like upstream and downstream pressures, flow rate, noise, vibration, temperature, etc. Beside the direct measurements, the system may also simulate the flow conditions and compute approximate values of the above parameters using a pump model, such as a computational fluid dynamics (CFD) model. The system then performs signature analysis of these measured and/or simulated parameters to ascertain wear, failure, or other deleterious effects on pump performance. Based on the signature analysis, the system can predict the future state or health of various pump components, so that the pump operator can control the pump's remaining useful life by altering the pump operation to redistribute the stress on these pump components.

Although the system of the '016 patent offers a way to extend the pump's useful life, it may not be able to quantitatively predict the pump's remaining useful life. In particular, no solution is given to quantitatively evaluate how cavitation may affect the pump's life expectancy. Thus, the operator cannot accurately plan a maintenance schedule. Moreover, though mentioning the substitution of actual measurements with CFD simulation, the '016 patent does not suggest using the CFD simulation to simulate cavitation or to predict the remaining useful life.

The disclosed system is directed to overcoming one or more of the problems set forth above and/or other problems of the prior art.

### SUMMARY OF THE INVENTION

In one aspect, the present disclosure is directed to a prognostic method implemented by a controller. The method includes obtaining one or more performance parameters of a machine. The method also includes determining whether cavitation occurs based on the one or more performance parameters. If cavitation occurs, the method includes simulating, based on the one or more performance parameters, the occurrence of the cavitation using a computational fluid dynamics (CFD) model. The method further includes determining, based on output from the simulation of the cavitation, a remaining useful life of the machine using finite element analysis (FEA).

In another aspect, the present disclosure is directed to a model-based machine health prognostic system. The prognostic system includes a CFD simulator and a FEA engine. The CFD simulator is configured to simulate, based on one or more performance parameters, an occurrence of cavitation using a CFD model. The FEA engine is configured to determine, based on output from the simulation of the cavitation, a remaining useful life of the machine using FEA.

In yet another aspect, the present disclosure is directed to a non-transitory computer-readable storage medium storing instructions for providing a model-based health prognosis system for a machine. The instructions cause at least one processor to perform operations including obtaining one or more performance parameters of the machine. The operations also include determining whether cavitation occurs based on the one or more performance parameters. If cavitation occurs, the operations include simulating, based on the one or more performance parameters, the occurrence of the cavitation using a CFD model. The operations further include determining, based on output from the simulation of the cavitation, a remaining useful life of the machine using FEA.

### BRIEF DESCRIPTION OF THE DRAWINGS

FIG. 1 is a schematic illustration of an exemplary pump employing a prognostic system for predicting a remaining useful life of the pump, according to an exemplary embodiment;

FIG. 2 is a schematic illustration of using a finite element analysis (FEA) to predict a remaining useful life of a machine when no cavitation occurs, according to an exemplary embodiment;

FIG. 3 is a schematic illustration of combining a computational fluid dynamics (CFD) simulation and FEA to predict a remaining useful life of a machine when cavitation occurs, according to an exemplary embodiment; and

FIG. 4 is a flowchart illustrating a method for providing a prognosis of machine health, according to an exemplary embodiment.

### DETAILED DESCRIPTION

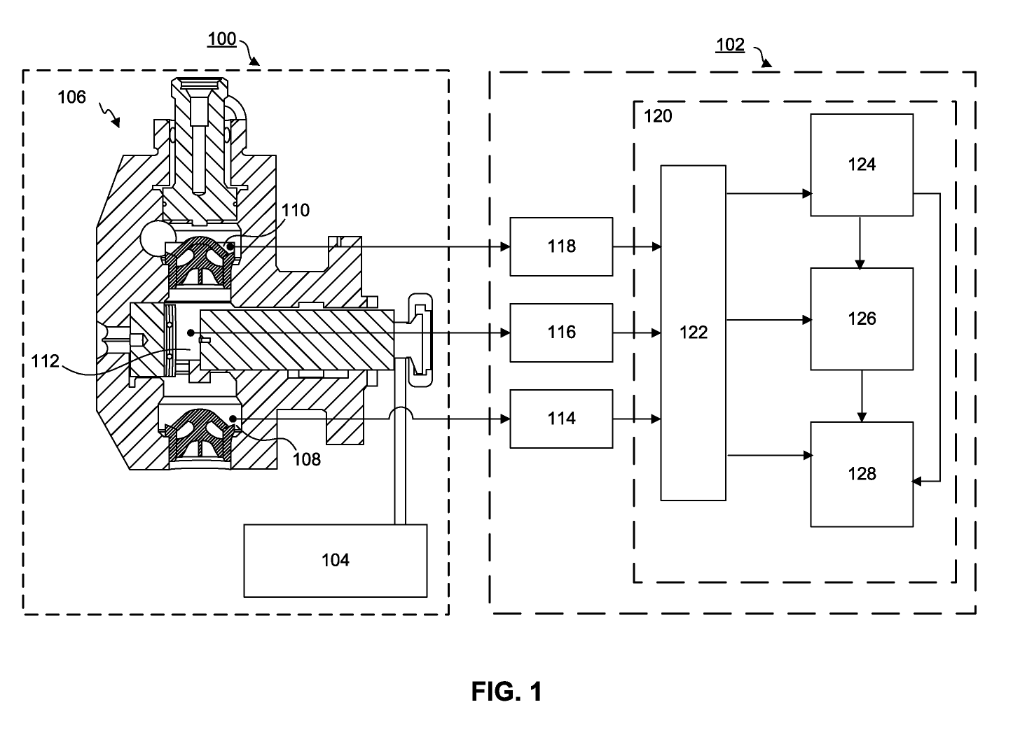

For discussion purposes only, the principles of the present disclosure are described in connection with the exemplary hydraulic pump depicted in FIG. 1. Those skilled in the art will recognize that the principles of the present disclosure may be applied to any type of hydrodynamic component, including, but not limited to, pumps, turbines, valves, propellers, pipes for transporting fluids, and any other component exposed to a flowing fluid. In addition, it will also be readily apparent to those skilled in the art that the principles of the present disclosure may be utilized with components experiencing cavitation in the absence of actual flowing fluid. The term “machine” in this disclosure is used to mean both an assembly of components, such as a pump, and individual components within an assembly, such as a valve.

FIG. 1 illustrates an exemplary hydraulic pump 100. For example, the pump 100 may be a reciprocating pump used in a hydraulic fracturing operation, i.e., a frac rig pump. Referring to FIG. 1, the pump 100 employs a pump health prognostic system 102 in accordance with embodiments of the present disclosure.

The pump 100 includes a suitable power source 104 and a fluid end 106 driven by the power source 104. The power source 104 may include but is not limited to, internal combustion engines, gas turbine engines, generator sets, and other types of power sources known to those skilled in the art.

The fluid end 106 includes at least a suction manifold 108, a discharge manifold 110, and multiple cylinders 112 located between the suction manifold 108 and the discharge manifold 110 (only one cylinder 112 visible in the cross-sectional view of the pump 100 in FIG. 1). The suction manifold 108 may be configured to receive a fracking fluid that is pre-mixed at a blender. The cylinders 112 are provided with movable components therein, such as reciprocating plungers or pistons, which are configured to pressurize the fracking fluid during operation. The discharge manifold 110 is configured to output the pressurized fracking fluid into a wellbore for fracturing deep-rock formations located under the earth's surface.

Also referring to FIG. 1, the prognostic system 102 includes a plurality of sensors, including a first sensor 114, a second sensor 116, multiple third sensors 118. Only one third sensor 118 is shown to correspond with the cross-sectional view of the pump 100 in the illustrated embodiment of FIG. 1. Moreover, the prognostic system 102 includes a controller 120, which further includes a data acquisition engine 122, a signature analysis engine 124, a computational fluid dynamics (CFD) simulator 126, and a finite element analysis (FEA) engine 128.

As shown in FIG. 1, the first sensor 114 is associated with the suction manifold 108 and is configured to measure and output a performance parameter associated with the suction manifold 108. The second sensor 116 is associated with the discharge manifold 110 and configured to measure and output a performance parameter associated with the discharge manifold 110. Each of the third sensors 118 is associated with at least one cylinder 112 and configured to measure and output a performance parameter associated with the corresponding cylinder 112. A third sensor 118 may be provided for each corresponding cylinder 112 or, alternatively, multiple cylinders 112 may share a common third sensor 118.

In exemplary embodiments, the performance parameter may include pressure, vibration, temperature, flow rate, etc. Accordingly, the sensors 114, 116, and 118 may include one or more of a pressure transducer configured to measure the pressure on a pump surface, an accelerometer configured to measure the vibration of the pump wall, a thermometer configured to measure the pump temperature, and a flow meter configured to measure the flow rate of the fracking fluid at various positions inside the pump.

As shown in FIG. 1, the data acquisition engine 122 is configured to obtain real-time performance parameters from at least one of the sensors 114-118. The data acquisition engine 122 may include one or more communication modules configured to facilitate data communications between the plurality of sensors and the data acquisition engine 122. The communication modules may include hardware and software that enable the modules to receive and/or send data messages through wired or wireless communications. The wireless communications may include satellite, cellular, infrared, WiFi, and any other type of wireless communication that enables the data acquisition engine 122 to wirelessly exchange information with the plurality of sensors.

With continued reference to FIG. 1, the signature analysis engine 124 is configured to monitor performance parameters of the pump 100 and perform signature analysis on these performance parameters. The monitored performance parameters may include the parameters detected by the sensors 114-118, such as suction pressure, discharge pressure, in-cylinder pressure, etc. The monitored performance parameters may also include other parameters, such as pump torque, pump speed, etc. Typically, the failure modes of the pump 100 are characterized and their corresponding signatures in the performance parameters are studied. By extracting signature information from the performance parameters, the signature analysis engine 124 may detect the occurrence of cavitation and other pump damage or failure.

The signature analysis engine 124 may extract the signature information using various techniques, such as frequency analysis employing Fourier transformation, data pattern recognition techniques, etc. For example, the signature analysis engine 124 may convert suction pressure detected at the suction manifold 108 into a frequency response of pressure. In the frequency response, the pressure amplitudes at certain frequencies may be related to a cavity formation, a bubble collapse, or a leakage event at the suction manifold 108. Higher amplitudes may be representative of a significant cavity formation, bubble collapse, or leakage. In some embodiments, the frequency response information is generated using a band pass filter in a time domain so that the cavitation and/or leakage related frequencies may be separated from frequencies of healthy pump characteristics. Similarly, the signature analysis engine 124 may perform the frequency analysis on the discharge pressure at the discharge manifold 110 and in-cylinder pressure at one of the cylinders 112. This way, the signature analysis engine 124 may determine cavitation and/or leakage information associated with different pump parts and identify the parts at which cavitation damage and/or leakage are suspected to have occurred.

For another example, the signature analysis engine 124 may compare current values of a selected performance parameter (e.g., vibration amplitude or frequency of the pump 100) with corresponding historical values and/or theoretical values in the time domain. The historical values may be obtained when the pump 100 was operating under healthy and normal operating conditions, such as conditions without cavitation or leakage. The theoretical values may be calculated using empirical data, statistical models, simulation models, or experimental test data pertaining to previous trial runs of the pump 100. By the comparison, the signature analysis engine 124 may detect variances between the current values and at least one of the historical values or theoretical values. The variances may be indicative of cavitation or other mode of failure occurring at the surface location.

In the present disclosure, it is contemplated that the signature analysis engine 124 may determine the performance signature using any techniques, formulae, algorithms, or routines that are known to those skilled in the art without deviating from the spirit of the present disclosure. Based on the signature analysis results, the signature analysis engine 124 may detect the occurrence of cavitation and identify the location in the pump 100 where cavitation damage is suspected.

Referring to FIG. 1, the signature analysis engine 124 is in communication with a CFD simulator 126 and may notify the CFD simulator 126 about the suspected cavitation damage. The CFD simulator 126 is configured to simulate the occurrence of cavitation in the pump 100 using a CFD model. It is contemplated that the CFD simulator 126 may run the simulation continuously, periodically, singularly, as a batch method, and/or as desired.

To run the CFD simulation, the CFD simulator 126 is configured to create a CFD model of a whole or part of the fluid end 106 and simulate approximate fluid flow and cavitation (e.g., vapor) parameters. The CFD model may be two dimensional or three dimensional. The CFD simulation is based on principles of fluid mechanics and uses numerical methods and algorithms to simulate the flow field in the pump 100 and, in particular, interactions of fluids and gases with the complex surfaces of the pump 100. The numerical methods and algorithms are computer implemented and aim to find numerical solutions to the governing partial differential equations descriptive of the flow behavior and interactions.

Once a suitable CFD model of the whole or part of the fluid end 106 is created and the appropriate fluid flow parameters are simulated, suitable cavitation (e.g., vapor) parameters may also be simulated. The CFD simulator 126 may use a suitable vapor and/or bubble model to simulate the cavitation parameters. The vapor and/or bubble model may include, but is not limited to, simulations that include the generation and collapse of bubbles within the simulated fluid flow.

The input parameters for the CFD simulation and vapor/bubble models may include pump performance parameters such as engine speed, pump speed, suction pressure, discharge pressure, in-cylinder pressure, pump vibration, etc. The output of the CFD simulation may include a pressure distribution in the fluid end 106. Such pressure distribution is time dependent and evolves as the cavitation progresses. Based on the pressure distribution, the CFD simulator 126 may map the bubble collapse shock wave and identify a flow washout location.

In some embodiments, after the suitable CFD model, including the simulated fluid flow and cavitation parameters, of the hydraulic component has been created, the CFD simulator 126 may also select a surface location within the CFD model of the fluid end 106. It is contemplated that one or more locations on a single surface and/or a plurality of surfaces may be selected. The selected surface location may be the location where cavitation damage is suspected by the signature analysis engine 124. Furthermore, it is contemplated that surface selection may be based on, for example, actual evidence of cavitation damage, mathematical calculations indicating the possibility of cavitation damage, and/or engineering estimations.

In these embodiments, the CFD simulator 126 may further be configured to determine at least one of the mean pressure and standard deviation, the standard deviation of the rate of change in pressure, the mean void percentage and standard deviation, the standard deviation of the rate of change in void percentage, and the acoustic pressure for the fluid flow at the selected surface location. The definitions, formulae, and calculation methods for the established concepts of mean, standard deviation, and rate of change are known to those skilled in the art. For example, the CFD simulator 126 may calculate the mean pressure at the selected location by making an arithmetic average of multiple simulated pressure values. The time interval between each simulated pressure may be dependent on the characteristics of the fluid flow and/or the shape of the hydraulic component. Furthermore, the time interval between each pressure value may be constant or may be varied as desired.

Referring to FIG. 1, the CFD simulator 126 is in communication with a FEA engine 128. After each CFD simulation, the CFD simulator 126 may output one or more of the above-described simulation results to the FEA engine 128 for further calculating the remaining useful life of the pump 100.

The FEA engine 128 is configured to run FEA to analyze the structural stress on the pump 100 and to predict the remaining useful life of the pump 100. Similar to the CFD simulation, the FEA is based on principles of solid mechanics and uses numerical methods and algorithms to find approximate solutions to a plurality of partial differential equation under given boundary conditions.

Specifically, the FEA engine 128 may retrieve structural information (e.g., geometric parameters) of the pump 100 and establish a finite element model of the pump 100. The finite element model may include a plurality of FEA elements interconnected at a plurality of FEA nodes. The FEA elements may have shapes like a tetrahedral shape, a hexahedral shape, a pyramid shape, and a wedge shape. The FEA elements may have an element shape function of any order, such as linear, parabolic, cubic, etc. The FEA nodes may be located at vertexes of the FEA elements, along the edges of FEA elements, and on the faces of FEA elements.

Next, the FEA engine 128 may solve the finite element model to obtain nodal force data at each FEA node, using the input parameters received from the CFD simulator 126, and other suitable parameters, such as the performance parameters generated by the first sensor 114, the second sensor 116, or third sensors 118. The FEA engine 128 may then use the nodal force data to calculate the structural stress, from which the FEA engine 128 may further calculate the probability of fatigue failure or the accumulated damage over time. Further, based on the probability of fatigue failure or accumulated damage over time, the FEA engine 128 may calculate the remaining useful life of the pump 100 and the associated standard deviation.

In exemplary embodiments, if the signature analysis engine 122 determines that no cavitation occurs in the pump 100 and thus no CFD simulation is needed, the prognostic system 102 may bypass the CFD simulator 126 and instruct the FEA engine 128 to directly determine the remaining useful life. This way, the computing resources can be saved and the system response time may be shortened.

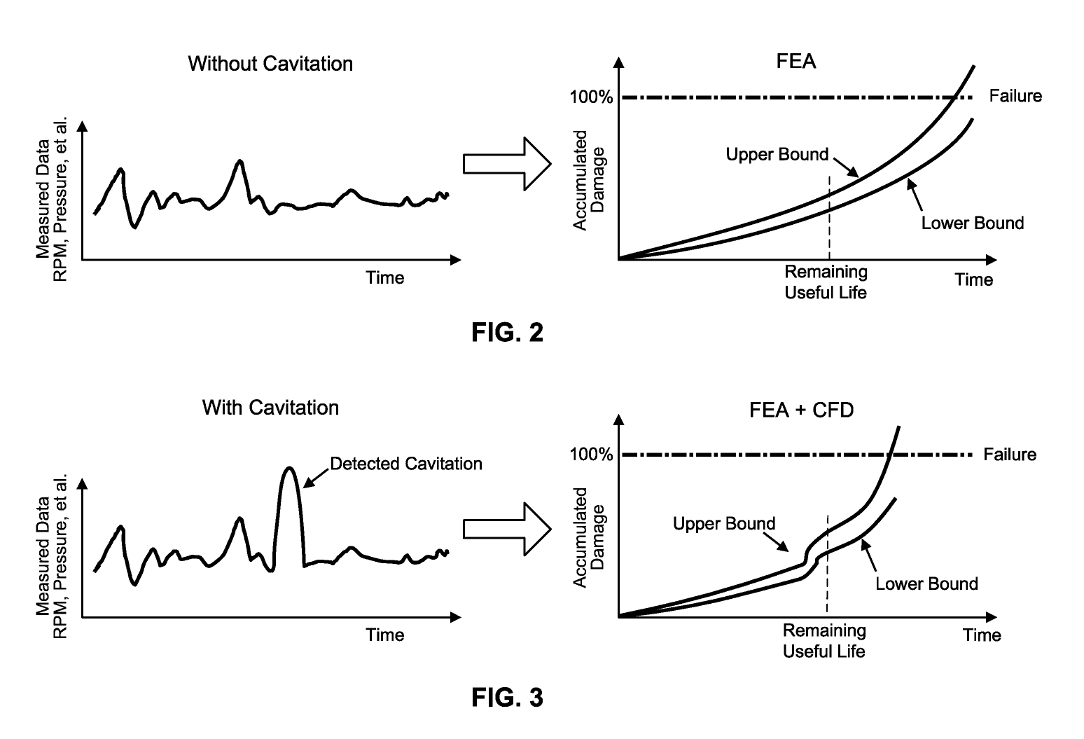

FIGS. 2 and 3 compare the remaining useful lives without and with cavitation. FIG. 2 illustrates using the FEA alone to predict the remaining useful life without cavitation. Referring to FIG. 2, the plot on the left side shows the measured performance data of the pump 100, such as suction pressure, discharge pressure, pump speed, etc. The signature analysis engine 124 determines that signatures of the measured performance data indicate no cavitation has occurred. Thus, no CFD simulation is initiated. Rather, the FEA engine 128 directly determines the remaining useful life. The right side of FIG. 2 shows an accumulated damage curve of the pump 100, derived from FEA alone. The accumulated damage curve grows over time and has a standard deviation, reflected as an upper bound and a lower bound. The fluid end 106 reaches the maximum useful life when the accumulated damage reaches 100%. Due to the upper and low bounds, the predicted remaining useful time at a particular point in time is also represented by a time range.

FIG. 3 illustrates combining the CFD simulation and the FEA to predict the remaining useful life when cavitation has occurred. Referring to FIG. 3, the plot on the left side shows the measured performance data of the pump 100. Based on the measured performance data, the signature analysis engine 124 detects an occurrence of cavitation and may identify a location where cavitation damage is suspected. Thus, the controller 120 instructs the CFD simulator 126 to simulate the occurrence of the cavitation. The FEA engine 128 then uses the CFD simulation results to compute the remaining useful life. The right side of FIG. 3 shows an accumulated damage curve of the pump 100, derived from both the CFD simulation and the FEA. The accumulated damage curve grows abruptly when cavitation occurs. Accordingly, the predicted remaining useful life is abruptly shortened due to the cavitation. If a catastrophic failure happens due to the cavitation, the pump life will be significantly reduced or ended.

In exemplary embodiments, the controller 120 may take many forms, including, for example, a computer based system, a microprocessor based system, a microcontroller, an electronic control module (ECM), an electronic control unit (ECU), or any other suitable control type circuit or system. The controller 120 may include various components that cooperate to run the signature analysis, CFD simulation, and FEA. For example, the controller 120 may include one or more processors, a memory, a storage device, an input/output (I/O) device.

The one or more processors may include one or more commercially available microprocessors, microcontrollers, digital signal processors (DSPs), and other similar devices that may be configured to perform the functions of the one or more processors.

The memory may include one or more devices configured to store information used by the processor to perform certain functions related to the disclosed embodiments. For example, the memory may store one or more programs loaded from the storage device or elsewhere that, when executed, enable the controller 120 to run the signature analysis, CFD simulation, and FEA. The memory may also store the historical values and theoretical values of the performance parameters used in the signature analysis.

The storage device may include a volatile or non-volatile, magnetic, semiconductor, tape, optical, removable, nonremovable, or other type of storage device or computer-readable medium.

The controller 120 may also include one or more of an application-specific integrated circuit (ASIC), a field-programmable gate array (FPGA), a computer system, and a logic circuit, configured to allow the controller 120 to function in accordance with the disclosed embodiments. Accordingly, the memory of the controller 120 may include, for example, the flash memory of an ASIC, flip-flops in an FPGA, the random access memory of a computer system, a memory circuit contained in a logic circuit, etc.

The I/O devices may include one or more digital and/or analog communication devices that allow the controller 120 to communicate with other systems and devices. For example, the I/O device may include a display interface that forwards graphics, text, and other data produced by the controller 120 to a display for presentation. The display can show a remaining useful life estimator.

The controller 120 may alternatively or additionally be communicatively coupled with an external computer system. It should also be appreciated that the controller 120 could readily be embodied in a general pump control system capable of controlling numerous pump operations. The controller 120 may communicate with other components of the control system via datalinks or other methods. Various other known circuits may be associated with the controller 120, including power supply circuitry, signal-conditioning circuitry, and communication circuitry.

In exemplary embodiments, the controller 120 may be part of an onboard system, such as an ECM with imbedded code implemented on it. Such an onboard prognostic system 102 can provide automatic, online, and real-time determination of the remaining useful life for use by a pump operator to plan the maintenance schedule or adjust the usage of the pump 100.

Alternatively, the controller 120 may be offboard and located in a remote data processing center. The controller 120 may wirelessly receive the pump performance data from the sensors 114-118 and run higher fidelity CFD simulation and FEA to generate more accurate prediction. The controller 120 then may send the prognostic results to the pump operator at the worksite.

### INDUSTRIAL APPLICABILITY

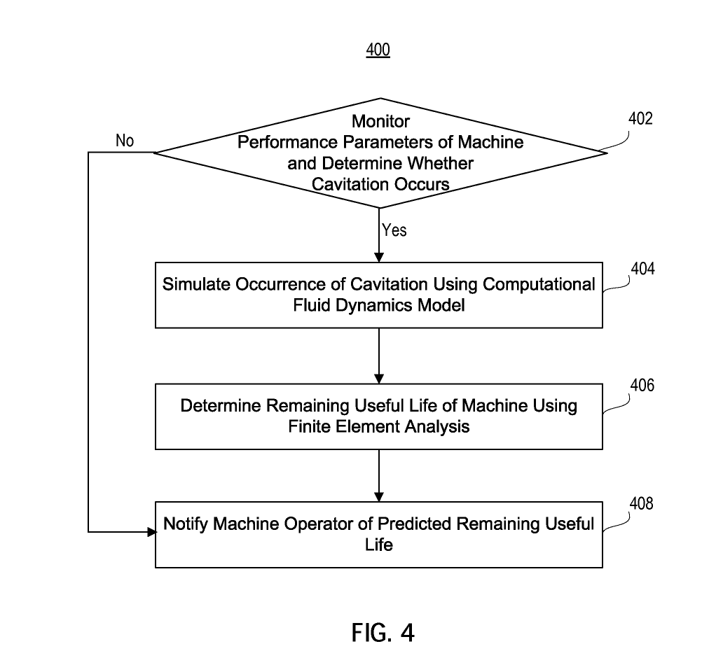

The disclosed machine health prognostic system 102 may be applicable to any machine where the structural damage of the machine may be determined by CFD simulation and FEA. The prognostic system 102 provides a quantitative estimate of the remaining useful time of the machine. Moreover, the prognostic system 102 accurately evaluates the effect of cavitation on the machine life expectancy. Thus, a machine operator can use the prognostic system 102 to accurately plan a maintenance schedule to avoid machine down time and to save the waste of premature maintenance. For example, the prognostic system 102 may be widely used in hydraulic fracturing operations to monitor the health of a frac rig pump. Operation of the prognostic system 102 will now be described in connection with the flowchart of FIG. 4.

In step 402, the prognostic system 102 monitors performance parameters of the machine and determines whether cavitation occurs. Based on the characterization of machine failure modes and their related signatures, one or more parameters with signatures representing cavitation occurrence may be selected and monitored by the prognostic system 102. The prognostic system 102 may use various techniques to extract signature information from the performance parameters and determine whether a cavitation occurrence is present. If cavitation is detected, the prognostic system 102 proceeds to step 404. If not, the prognostic system 102 may skip step 404 and directly proceed to step 406.

In step 404, the prognostic system 102 simulates the occurrence of the cavitation using a CFD model. The input parameters for the CFD simulation may include, but are not limited to, pressure, vibration, temperature, flow rate, pump speed, engine speed, etc. These performance parameters may be measured at various positions in the pump 100. However, for well calibrated CFD models, the required input parameters may be reduced to pressure data collected at the suction manifold 108, the discharge manifold 110, and the cylinders 112. The CFD simulation may be configured to generate a pressure distribution that evolves over time as the cavitation progresses. The CFD simulation may further be configured to map the cavitation collapse shock wave on a surface of the machine and to identify the flow washout location.

In step 406, the prognostic system 102 determines a remaining useful life of the machine using FEA. The prognostic system 102 may use structural information of the machine to create a finite element model. If cavitation is detected in step 402, the prognostic system 102 may combine the finite element model with the CFD simulation results to determine the remaining useful life. If no cavitation is detected in step 402, the prognostic system 102 may determine the remaining useful life only using FEA, without running the CFD simulation.

In step 408, the prognostic system 102 notifies the machine operator of the predicted remaining useful life. The prognostic system 102 may be integrated into an onboard system or may be located in a remote offboard data processing center. Different CFD and finite element models may be developed for the onboard and offboard systems based on their different hardware and software environments. An onboard prognostic system 102 may provide automatic, online, and real-time determination of the remaining useful life, while an offboard prognostic system 102 may employ higher fidelity CFD and finite element models and better computational power to provide more accurate life prediction. The offline results may be used to validate the online results. If a discrepancy occurs, the onboard CFD and finite element models may be adjusted to correct for any deficiencies.

The disclosed exemplary embodiments provide a flexible and quantitative solution to predicting the remaining useful life of a machine. The disclosed prognostic system combines CFD simulation and FEA to quantitatively evaluate the effect of cavitation on the machine's life expectancy. With the quantified results, the machine operator can accurately schedule maintenance or adjust operations of the machine. Moreover, the prognostic system can predict the remaining useful life using only a limited number of sensors installed in selected locations, saving the effort and expenses of spreading many sensors throughout an entire machine with complex structures. For example, a prognostic system coupled with the exemplary pump 100 may only require pressure data detected at the suction manifold, the discharge manifold, and the cylinders. Further, the prognostic system 102 may use signature analysis to detect an occurrence of a cavitation. If no cavitation is detected, the CFD simulation may be omitted from the life expectancy determination, such that the system response time can be shortened. In addition, the prognostic system may be flexibly implemented onboard or offboard. The onboard system can produce results in real time that enable the machine operators to quickly respond to worksite situations. The offboard system can provide highly reliable results that enable the machine operators to make accurate mid-term or long-term planning for maintenance. The combination of the onboard system and offboard system provides a comprehensive solution for machine and worksite management.

It will be apparent to those skilled in the art that various modifications and variations can be made to the disclosed prognostic system. Other embodiments will be apparent to those skilled in the art from consideration of the specification and practice of the present disclosure. It is intended that the specification and examples be considered as exemplary only, with a true scope being indicated by the following claims and their equivalents.

What is claimed is:

1. A prognostic method implemented by a controller, comprising:
obtaining one or more performance parameters of a machine;
determining whether cavitation occurs based on the one or more performance parameters;
if cavitation occurs, simulating, based on the one or more performance parameters, the occurrence of the cavitation using a computational fluid dynamics (CFD) model; and
determining, based on output from the simulation of the cavitation, a remaining useful life of the machine using finite element analysis (FEA).

2. The method of claim 1, further comprising:
if no cavitation occurs, determining the remaining useful life of the machine using FEA, without simulating the occurrence of the cavitation.

3. The method of claim 1, wherein determining whether the cavitation occurs further comprises:
extracting machine signature information from the one or more performance parameters; and
determining whether the machine signature information indicates the occurrence of cavitation.

4. The method of claim 1, wherein the one or more performance parameters include one or more of pressure, vibration, temperature, flow rate, pump speed, pump torque, and engine speed.

5. The method of claim 1, wherein simulating the occurrence of cavitation further comprises:
simulating cavitation formation and bubble collapse;
determining a pressure distribution;
mapping a cavitation collapse shock wave; and
identifying a flow washout location.

6. The method of claim 1, wherein the controller is onboard the machine.

7. The method of claim 6, wherein the machine is a frac rig pump.

8. A model-based health prognostic system for a machine, comprising:
a CFD simulator configured to simulate, based on one or more performance parameters, an occurrence of cavitation using a CFD model; and
a FEA engine configured to determine, based on output from the simulation of the cavitation, a remaining useful life of the machine using FEA.

9. The system of claim 8, further comprising:
a signature analysis engine configured to determine whether cavitation occurs based on the one or more performance parameters;
wherein the FEA engine is further configured to, if no cavitation occurs, determine the remaining useful life of the machine using FEA, without using the output from the simulation of the cavitation.

10. The system of claim 9, wherein the signature analysis engine is further configured to:
extract machine signature information from the one or more performance parameters; and
determine whether the machine signature information indicates the occurrence of the cavitation.

11. The system of claim 8, further comprising:
one or more sensors configured to detect the one or more performance parameters.

12. The system of claim 8, wherein the one or more performance parameters include one or more of pressure, vibration, temperature, flow rate, pump speed, pump torque, and engine speed.

13. The system of claim 8, wherein the CFD simulator is further configured to:
simulate cavitation formation and bubble collapse;
determine a pressure distribution;
map a cavitation collapse shock wave; and
identify a flow washout location.

14. The system of claim 8, further comprising:
a data acquisition engine configured to obtain the performance parameters in real time from one or more sensors through wired or wireless communications.

15. The system of claim 8, wherein the CFD simulator and the FEA engine are onboard the machine.

16. A non-transitory computer-readable storage medium storing instructions for providing a model-based health prognostic system for a machine, the instructions causing at least one processor to perform operations comprising:
obtaining one or more performance parameters of the machine;
determining whether cavitation occurs based on the one or more performance parameters;
if cavitation occurs, simulating, based on the one or more performance parameters, the occurrence of the cavitation using a CFD model; and
determining, based on output from the simulation of the cavitation, a remaining useful life of the machine using FEA.

17. The non-transitory computer-readable storage medium of claim 16, wherein the operations further comprise:
if no cavitation occurs, determining the remaining useful life of the machine using FEA, without simulating the occurrence of the cavitation.

18. The non-transitory computer-readable storage medium of claim 16, wherein determining whether the cavitation occurs further comprises:
extracting machine signature information from the one or more performance parameters; and
determining whether the machine signature information indicates the occurrence of the cavitation.

19. The non-transitory computer-readable storage medium of claim 16, wherein the one or more performance parameters include one or more of pressure, vibration, temperature, flow rate, pump speed, pump torque, and engine speed.

20. The non-transitory computer-readable storage medium of claim 16, wherein simulating the occurrence of the cavitation further comprises:
simulating cavitation formation and bubble collapse;
determining a pressure distribution;
mapping a cavitation collapse shock wave; and
identifying a flow washout location.
